(19) United States
(12) Patent Application Publication
(10) Pub. No.: US 2006/0047765 A1
(43) Pub. Date: Mar. 2, 2006

(54) Electronic mail communication system, electronic mail communication apparatus, electronic mail communication method, and storage medium storing electronic mail processing program

(75) Inventors: Tsuyoshi Mizoi, Saitama (JP); Hironori Niwa, Saitama (JP); Kouji Yorimoto, Saitama (JP); Hidetaka Hama, Saitama (JP); Yasushi Sakata, Saitama (JP); Ryuji Inaba, Saitama (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/195,766

(22) Filed: Aug. 3, 2005

(30) Foreign Application Priority Data
Sep. 2, 2004 (JP) 2004-255972

(51) Int. Cl. G06F 15/16

(52) U.S. Cl. 709/206; 709/207

(57) ABSTRACT

An electronic mail communication system for sending an electronic mail from a sending side communication apparatus to a reception side communication apparatus through a network, in which the sending side communication apparatus includes: a processing instruction unit that instructs a content of processing of the attached file to be performed in the reception side communication apparatus; an electronic mail generation unit that generates an electronic mail including the processing content; and a sending unit that sends the electronic mail to the reception side communication apparatus; and the reception side communication apparatus includes: a reception unit that receives the electronic mail including the processing content; an extraction unit that extracts the processing content from the electronic mail; and a processing unit that implements processing of the electronic mail on the basis of the processing content extracted by the extraction unit.

### BACKGROUND OF THE INVENTION

1. Field of the Invention

The present invention relates to an electronic mail communication system, electronic mail communication apparatus, electronic mail communication method, and storage medium storing electronic mail processing program for processing a message content by transferring a message by an electronic mail, and more particularly to an electronic mail communication system, electronic mail communication apparatus, electronic mail communication method, and storage medium storing electronic mail processing program with which the content of the electronic mail including an attached file can be automatically processed on the basis of the intent of the electronic mail sender.

2. Description of the Related Art

Generally, reception of an electronic mail is performed actively by the receiver from the mailer on the receiver side to the mail server, using such a protocol as POP3 (Post Office Protocol version 3), IMAP4 (Internet Message Access Protocol version 4), or the like. In other words, when viewed from the sender, the reception of an electronic mail is passive.

Therefore, the processing provided for the text and the like of an electronic mail including an attached file is performed dependently on the contents of the setting on the receiver side in consideration of the security aspect.

With a related art as disclosed in Japanese Patent Application Laid-Open No. 2002-41418, the system can be set such that the attached data will not be automatically printing-outputted with the reception of an electronic mail, and only when an output command is issued through the password operation and the like using a child machine B1, B2, or B3, the attached data which has not yet been outputted can be printing-outputted.

However, in recent years, when sending an electronic mail to a limited opposite party (receiver) using the communication technology, such as the LAN (Local Area Network) represented by the VLAN (Virtual Local Area Network), which is operated without the need for passing through the dial-up line network; the VPN (Virtual Private Network), which utilizes the dial-up line network, but provides a security and convenience which could be provided if a private line were used, or the like; an application which has realized a high security, such as the group mail, or the like; or the like, it has been made possible to reflect the intent of the sender with a high security being assured.

However, with the related art as disclosed in Japanese Patent Application Laid-Open No. 2002-41418, there is a problem that the printing of an electronic mail is restricted due to the condition of the printing output apparatus on the receiver side or the circumstance of the receiver, thus the intent of the sender is not taken into consideration, and if it is indicated that the communication has been normally performed, the contents have not always been transferred to the receiver.

### SUMMARY OF THE INVENTION

Then, the present invention is intended to provide an electronic mail communication system, electronic mail communication apparatus, electronic mail communication method, and storage medium storing electronic mail processing program which can automatically process an electronic mail at the receiver side with priority being given to the intent of the sender of the electronic mail so that the establishment of the electronic mail communication means the completion of the message delivery.

An aspect of the present invention provides an electronic mail communication system for sending an electronic mail from a sending side communication apparatus to a reception side communication apparatus through a network, in which the sending side communication apparatus includes: a processing instruction unit that instructs, when sending the electronic mail including an attached file, a content of processing of the attached file to be performed in the reception side communication apparatus; an electronic mail generation unit that generates an electronic mail including the processing content instructed by the processing instruction unit; and a sending unit that sends the electronic mail generated by the electronic mail generation unit to the reception side communication apparatus; and the reception side communication apparatus includes: a reception unit that receives the electronic mail including the processing content from the sending side communication apparatus; an extraction unit that extracts the processing content from the electronic mail received by the reception unit; and a processing unit that implements processing of the electronic mail received by the reception unit on the basis of the processing content extracted by the extraction unit.

### BRIEF DESCRIPTION OF THE DRAWINGS

Embodiments of the present invention will be described in detail based on the following figures, wherein:

FIG. 1 is a drawing illustrating the entire configuration of the electronic mail communication system pertaining to the present invention;

FIG. 2 is a drawing illustrating the system configuration of the electronic mail communication system pertaining to the present invention;

FIG. 3 is a drawing illustrating the screen for selecting the printing instruction content in the electronic mail communication system of the present invention;

FIG. 4 is a drawing illustrating the screen for setting the password in the electronic mail communication system of the present invention;

FIG. 5 is a drawing illustrating the screen for telling the printing completion in the electronic mail communication system of the present invention; and

FIG. 6 is a flowchart illustrating the flow of the processing for providing a printing instruction content to an electronic mail and send out the electronic mail in the communication system of the present invention

### DETAILED DESCRIPTION OF THE INVENTION

An embodiment of the electronic mail communication system, electronic mail communication apparatus, electronic mail communication method, and storage medium storing electronic mail processing program pertaining to the present invention will be described in detail with reference to the attached drawings.

The electronic mail communication system of the present invention is applicable to the general processing of the components constituting an electronic mail, such as the text body, the header, the attached file, and the like, however, in the following embodiment, printing processing of the attached file of an electronic mail will be described as an example of processing.

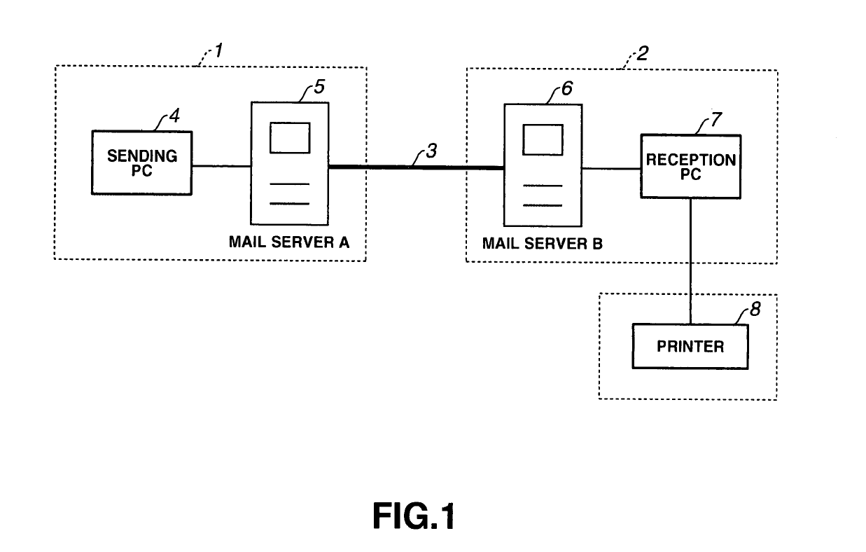

FIG. 1 is a drawing illustrating the entire configuration of the electronic mail communication system which is configured by applying the electronic mail communication system, electronic mail communication apparatus, electronic mail communication method, and electronic mail processing program pertaining to the present invention.

FIG. 1 illustrates that, with this electronic mail communication system, a sender network 1 for sending an electronic mail is connected to a receiver network 2 for receiving the electronic mail through a communication line 3. Herein, the communication line 3 indicates a communication line, such as the LAN, the internet line, or the like, with which electrical communication can be performed.

The sender network 1 is configured to include a sending PC 4 for performing preparation of an electronic mail, or the like, and a mail server 5 for performing sending and reception management of an electronic mail on the sender side. In order to carry out the communication, a router providing a gate way and servers offering a variety of services (such as the name server, the print server, and the like) are, of course, required, but only the main configuration is illustrated.

With the sending PC 4, an electronic mail with an attached file to be sent is prepared, and the prepared electronic mail is sent to the receiver network 2 through the mail server 5.

The receiver network 2 is configured to include a mail server 6 for performing sending and reception management of an electronic mail, a reception PC 7 which is designated as the destination of the electronic mail by the sending PC 4, and a printer 8 which prints the attached file of the electronic mail which has been sent. As with the sender network, a router and servers offering a variety of services (such as the name server, the print server, and the like) are required, but only the main configuration is illustrated.

The electronic mail with an attached file that has been prepared by the sending PC 4 is received by the mail server 6 through the mail server 5, and the mail server 6 transfers the electronic mail to the reception PC 7. The reception PC 7 receives the electronic mail, and on the basis of the instruction content of the electronic mail, a printing request is sent to the printer 8 in order to print the attached file of the electronic mail. The printer 8 prints the attached file of the electronic mail according to the printing request.

By these processings, the attached file of the electronic mail can be printed with the intent of the sender being taken into account.

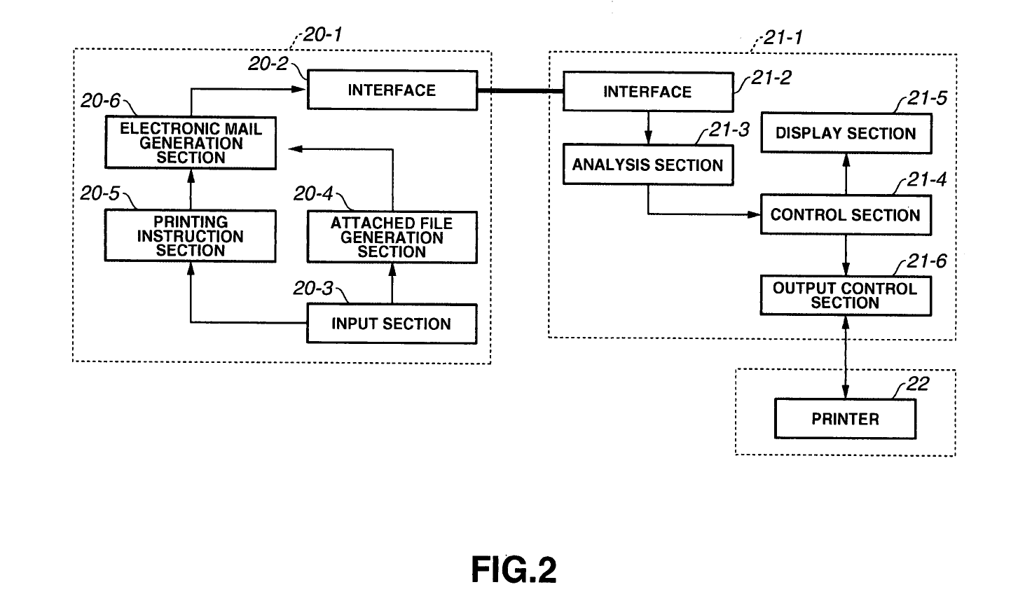

FIG. 2 is a drawing illustrating the system configuration of the electronic mail communication system pertaining to the present invention.

FIG. 2 illustrates the configuration in which a sender network 20-1 for sending an electronic mail with an attached file is connected with a receiver network 2 1-1 for receiving the electronic mail with an attached file that has been sent from the sender network 20-1 through a communication line 23.

The sender network 20-1 is configured to include an interface 20-2, an input section 20-3, an attached file generation section 20-4, a printing instruction section 20-5, and an electronic mail generation section 20-6.

The interface 20-2 provides a connection portion for carrying out electrical communication with the receiver network 2 1-1.

The input section 20-3 is for the user inputting an instruction when generating a file to be attached to an electronic mail, or giving a printing instruction.

The attached file generation section 20-4 is for generating an attached file to be printed in the receiver network 21-1. The attached file which has been generated here is printed by a printer 22.

The printing instruction section 20-5 is for giving a printing instruction for the attached file generated by the attached file generation section 20-4. As the instruction content, an appropriate one of the followings is selected.
(1) Automatically print the attached file entirely;
(2) Automatically print only part of the attached file;
(3) Automatic printing is not performed (priority is given to the setting by the receiver); and
(4) Printing is inhibited (reference only).

The instruction content of that “automatic printing is not performed” as given in (3) above means that automatic printing is not to be performed with the intention of the sender side, in other words, that priority is to be given to the setting on the receiver side. The instruction content of that “printing is inhibited” as given in (4) above means that the attached file of the electronic mail is to be set such that it cannot be printed on the receiver side.

An appropriate one selected from these instruction contents is sent to the electronic mail generation section 20-6.

For example, when “automatically print the attached file entirely” as given in (1) above is selected as the printing instruction, the printer 8 on the receiver side will automatically print the whole of the attached file regardless of the printing setting by the receiver.

The electronic mail generation section 20-6 generates an electronic mail provided with an attached file and a printing instruction content on the basis of the attached file generated by the attached file generation section and the instruction content selected by the printing instruction section 20-5.

The receiver network 21-1 is configured to include an interface 21-2, an analysis section 21-3, a control section 21-4, and a display section 21-5, and an output control section 21-6, and a printer 22.

The interface 21-2 provides a connection portion for realizing electrical communication with the sender network 20-1.

The analysis section 21-3 analyzes the printing instruction content from the electronic mail with an attached file that has been sent from the sender, and sends the attached file together with the result of the analysis to the control section 21-4.

When the printing instruction section 20-5 in the sender network 20-1 has given an instruction of “automatically print the attached file entirely” as given in (1) above, the instruction of that automatically print the attached file entirely is sent together with the attached file.

The control section 21-4 performs printing control for the attached file on the basis of the printing instruction content which has been analyzed by the analysis section 21-3.

The printing control for the attached file can be performed on the basis of the printing instruction content as given by the printing instruction section 20-5; when a printing instruction of that “automatically print the attached file entirely” as given in (1) above is provided, the whole of the attached file is printed, and when a printing instruction of that “automatically print part of the attached file” as given in (2) above is provided, only the specified part is printed. Further, when a printing instruction of that “automatic printing is not performed (priority is given to the setting by the receiver)” as given in (3) above is provided, the processing is performed in accordance with the printing setting on the receiver side, and when a printing instruction of that “printing is inhibited (reference only)” as given in (4) above is provided, it is made impossible to perform the printing of the attached file.

Further, when a printing instruction as given in (1) or (2) above is provided, a screen indication of that “the attached file is being printed” may be given in the display section 21-5.

The control section 21-4 has at least one of the functions of processing on the basis of the above-mentioned four printing instruction contents. When the control section 21-4 has no functions for the printing instruction, the system may be configured such that the sender is informed thereof, or such that the functions possessed are offered to the sender and the sender selects an appropriate one of the printing instructions which can be given.

The display section 21-5 is for giving a screen indication of that “the attached file is being printed” or a screen indication of that “the attached file is inhibited to be printed”.

Thereby, that the received electronic mail with an attached file is automatically being printed or that the printing is inhibited can be transmitted to the receiver, which allows the information to be transmitted more positively.

The output control section 21-6 is for performing printing control for the attached file sent by the control section 21-4, such as specifying the order of printing, selecting the printer as the destination of the output, or the like.

The system may be configured such that the processing completion report about whether the printing request given to the printer 22 has been normally processed or not is monitored the result thereof is notified to the sender or to the receiver. Thereby, it can be identified that the attached file of the electronic mail has been surely printed. the output control section 21-6 monitors The printer 22 is for printing the attached file on the printing request issued by the output control section 21-6.

With such a configuration, the attached file of the electronic mail sent from the sender side to the receiver can be printed as intended by the sender side, and the receiver can easily know that the attached file of the received electronic mail has been printed.

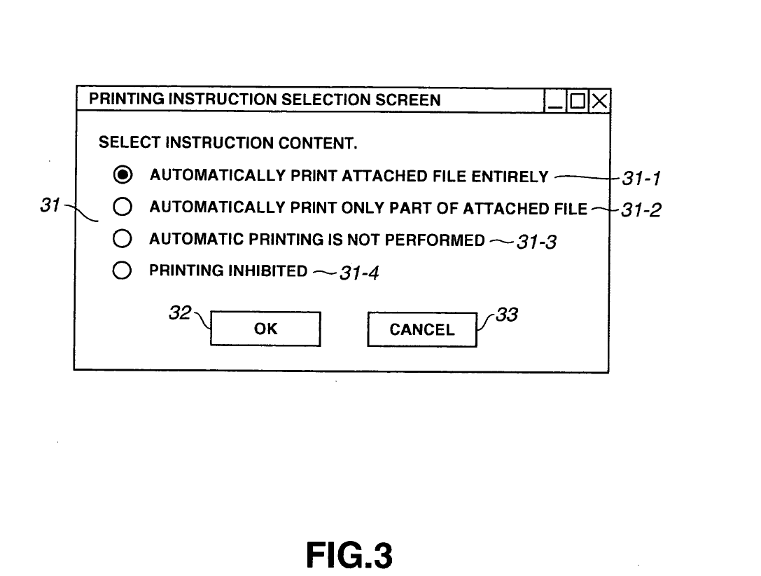

FIG. 3 is a drawing illustrating the screen for selecting the printing instruction content in the electronic mail communication system of the present invention, and with this screen, any one of the four different instruction items provided for the printing instruction section 20-5 as shown in FIG. 2 can be selected.

FIG. 3 is a screen with which a particular printing instruction content can be selected when an electronic mail is to be sent, and the screen is that which can be invoked by using general electronic mail software, for example. By selecting any one of the instruction items 3 1, and depressing the OK pushbutton 32, the printing instruction content is provided for the electronic mail to be sent, and is sent together with the text of the electronic mail.

In addition, when a second instruction item 31-2 of the instruction items 31 is checked, the printing range for the automatic printing can be specified.

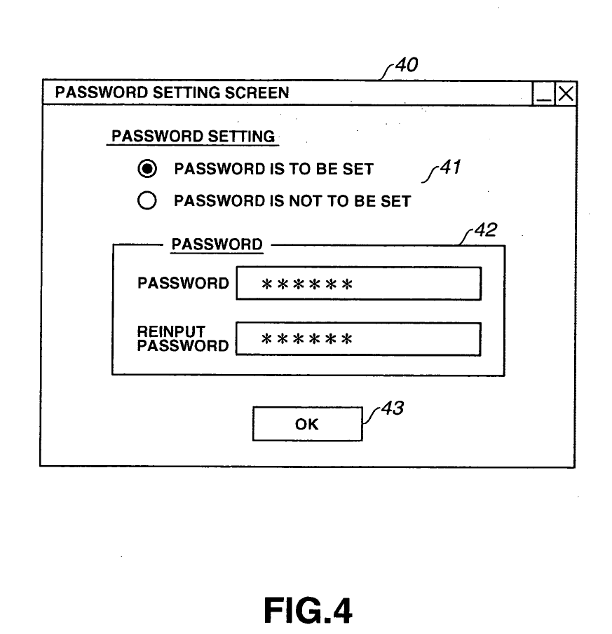

Further, when a fourth instruction item 31-4 is checked, a password setting screen 40 as shown in FIG. 4 is activated, and by selecting the item of “password is to be set”, the password can be set.

FIG. 4 is a drawing illustrating the screen for setting the password in the electronic mail communication system of the present invention.

In FIG. 4, when the item of “password is to be set” of the password setting selection items 41 provided for selecting either that the password is to be set or that it is not be set is checked, the password can be inputted in the password input area 42 for setting the password, and by depressing the OK pushbutton 43, the password can be set. Of course, when the item of “password is not to be set” of the password setting selection items 41 is checked, the password cannot be set.

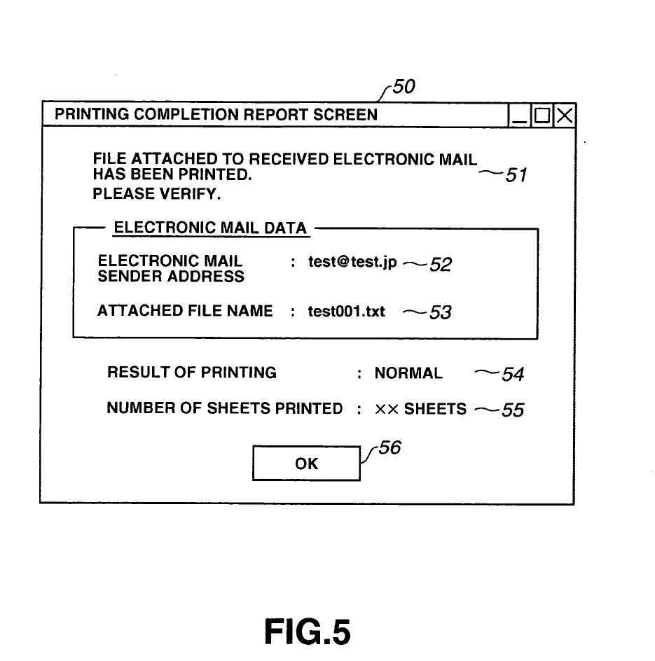

FIG. 5 is a drawing illustrating the screen for telling the printing completion in the electronic mail communication system of the present invention.

FIG. 5 shows a screen displayed on the processing terminal on the receiver side on which, for an electronic mail provided with an attached file and a printing instruction content sent from the sender side, the result of the printing thereof performed on the content of the printing instruction is reported.

A statement 51 telling the completion of the printing is followed by the electronic mail sender address 52 and the attached file name 53, with the “normal/abnormal” result 54 of printing the attached file having the attached file name 53 that has been sent from the sender address 52 and the number of sheets printed 55 being indicated.

Thereby, the receiver of the electronic mail can receive a notification of an electronic mail, and further can know that the printing of an attached file of the electronic mail has been carried out.

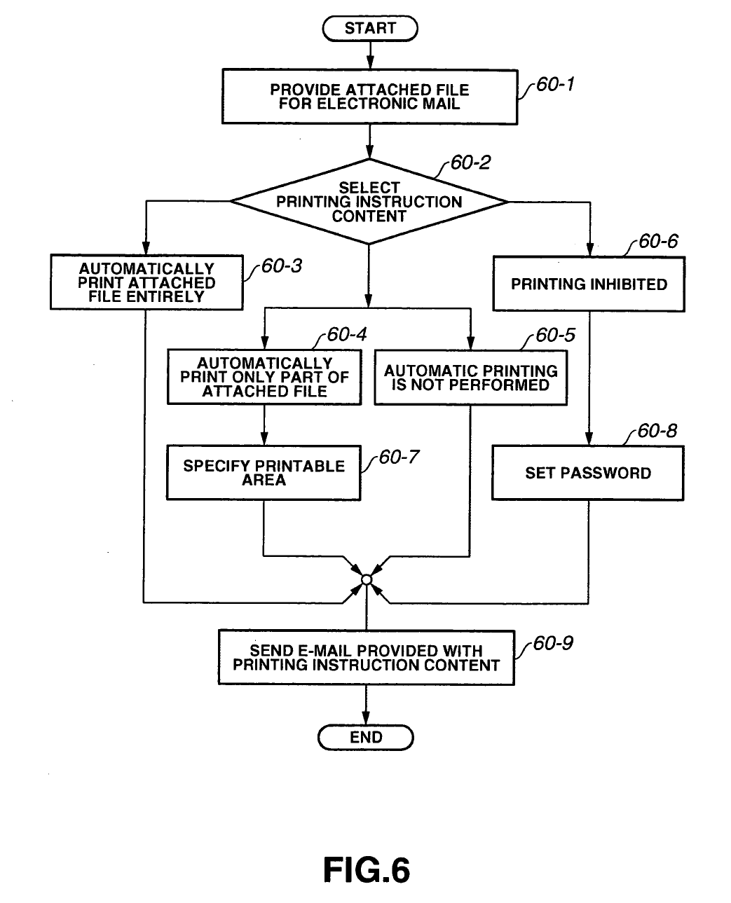

FIG. 6 is a flowchart illustrating the flow of the processing for providing a printing instruction content to an electronic mail and send out the electronic mail in the communication system of the present invention.

In FIG. 6, the processing is started when the sender generates an attached file, and the file is attached to then electronic mail (S60-1), and the printing instruction content for the attached file that is for the receiver side is selected (S60-2).

When the content selected is “automatically print the attached file entirely” as given in (1) above (S60-3), the printing instruction content is sent, being provided for the electronic mail (S60-9).

When the content selected is that “automatically print only part of the attached file” as given in (2) above (S60-4), the range of the part of the attached file that can be printed is specified (S60-7), the printing instruction content and the printing range are provided for the electronic mail, and sent (S60-9).

When the content selected is that “automatic printing is not performed” as given in (3) above (S60-5), the printing instruction content is provided for the electronic mail, and sent, in order to carry out the printing with priority being given to the setting on the receiver side (S60-9).

When the content selected is that “printing is inhibited” as given in (4) above (S60-6), the password is set (S60-8), the printing instruction and the password are encrypted, and sent by being attached to the electronic mail (S60-9).

By the above-described processing, in the present system, the file attached to the electronic mail can be printed on the basis of the printing instruction content sent by the sender, and further the printing range of the attached file can be specified.

Whereby, the establishment of the electronic mail communication can mean the completion of the message delivery.

The processing as given in the above-mentioned flowchart can also be realized with a computer-executable program.

As described above, a first aspect of the present invention provides an electronic mail communication system for sending an electronic mail from a sending side communication apparatus to a reception side communication apparatus through a network, in which the sending side communication apparatus includes: a processing instruction unit that instructs, when sending the electronic mail including an attached file, a content of processing of the attached file to be performed in the reception side communication apparatus; an electronic mail generation unit that generates an electronic mail including the processing content instructed by the processing instruction unit; and a sending unit that sends the electronic mail generated by the electronic mail generation unit to the reception side communication apparatus; and the reception side communication apparatus includes: a reception unit that receives the electronic mail including the processing content from the sending side communication apparatus; an extraction unit that extracts the processing content from the electronic mail received by the reception unit; and a processing unit that implements processing of the electronic mail received by the reception unit on the basis of the processing content extracted by the extraction unit.

Further, a second aspect of the present invention provides the electronic mail communication system in the first aspect of the invention, in which the processing instruction unit may instruct processing for automatically printing the attached file, and the processing unit may automatically print the attached file when receiving the electronic mail.

Further, a third aspect of the present invention provides the electronic mail communication system in the first aspect of the invention, in which the processing instruction unit may instruct processing for automatically printing a specified part of the attached file, and the processing unit may automatically print the specified part of the attached file when receiving the electronic mail.

Further, a fourth aspect of the present invention provides the electronic mail communication system in the third aspect of the invention, in which the processing instruction unit may include a printing range specification unit that specifies a printing range of the attached file.

Further, a fifth aspect of the present invention provides the electronic mail communication system in the first aspect of the invention, in which the processing instruction unit may instruct processing in which the attached file is processed in accordance with a setting in the reception side communication apparatus; and the processing unit may process the attached file in accordance with the setting in the reception side communication apparatus when receiving the electronic mail.

Further, a sixth aspect of the present invention provides the electronic mail communication system in the first aspect of the invention, in which the processing instruction unit may instruct processing in which printing of the attached file is inhibited; and the processing unit may inhibit printing of the attached file when receiving the electronic mail.

Further, a seventh aspect of the present invention provides the electronic mail communication system in the sixth aspect of the invention, in which the processing instruction unit may include: a password setting unit that sets a password; and the processing unit may permit the printing of the attached file which has been inhibited to be printed, when the password set by the password setting unit is inputted.

Further, an eighth aspect of the present invention provides an electronic mail communication apparatus for sending an electronic mail to a reception side communication apparatus through a network, including: a processing instruction unit that instructs, when sending the electronic mail including an attached file, a content of processing of the attached file to be performed in the reception side communication apparatus; an electronic mail generation unit that generates an electronic mail including the processing content instructed by the processing instruction unit; and a sending unit that sends the electronic mail generated by the electronic mail generation unit to the reception side communication apparatus.

Further, a ninth aspect of the present invention provides an electronic mail communication apparatus for receiving an electronic mail sent from a sending side communication apparatus through a network, including: a reception unit that receives an electronic mail including an instruction of a processing content for an attached file sent from the sending side communication apparatus; an extraction unit that extracts the processing content from the electronic mail received by the reception unit; and a processing unit that implements processing of the electronic mail received by the reception unit on the basis of the processing content extracted by the extraction unit.

Further, a tenth aspect of the present invention provides a controlling method for an electronic mail communication system for sending an electronic mail from a sending side communication apparatus to a reception side communication apparatus through a network, including: instructing, by a processing instruction unit of the sending side communication apparatus, a content of processing of an attached file to be performed in the reception side communication apparatus when sending the electronic mail including the attached file; generating, by an electronic mail generation unit of the sending side communication apparatus, an electronic mail including the processing content instructed by the processing instruction unit; sending, by a sending unit of the sending side communication apparatus, the electronic mail generated by the electronic mail generation unit to the reception side communication apparatus; receiving, by a reception unit of the reception side communication apparatus, the electronic mail including the processing content from the sending side communication apparatus; extracting, by an extraction unit of the reception side communication apparatus, the processing content from the electronic mail received by the reception unit; and implementing, by a processing unit of the reception side communication apparatus, processing of the electronic mail received by the reception unit on the basis of the processing content extracted by the extraction unit.

Further, an eleventh aspect of the present invention provides a storage medium readable by a computer, the storage medium storing an electronic mail processing program executable by the computer to perform a function for processing in an electronic mail communication system which sends an electronic mail from a sending side communication apparatus to a reception side communication apparatus through a network, the function including: inputting an instruction of a content of processing of an attached file to be performed in the reception side communication apparatus when sending the electronic mail including the attached file from the sending side communication apparatus; generating an electronic mail including the processing content inputted; sending the generated electronic mail to the reception side communication apparatus; receiving the electronic mail including the processing content from the sending side communication apparatus; extracting the processing content from the received electronic mail; and implementing processing of the received electronic mail on the basis of the extracted processing content.

According to the above-mentioned aspects of the present invention, the system is configured such that the processing content at the time of reception of an electronic mail can be instructed by the electronic mail sender, thus the processing of an electronic mail can be actively performed by the sender itself with priority being given to the intent of the sender, which provides an effect of that the importance of the electronic mail sent is emphasized, while information outflow to any third party can be avoided.

The present invention is not limited to the embodiment as described above and as illustrated in the diagrams, but it can be embodied, being modified or altered as appropriate within the spirit and scope of the present invention as defined by the appended claims.

The present invention is applicable to electronic mail communication systems, electronic mail communication apparatuses, electronic mail communication methods and storage media storing electronic mail processing programs for processing the content of an electronic mail including an attached file, and is particularly useful for printing the text and the like of an electronic mail including an attached file according to the intent of the sender in terms of the processing content, and actively avoiding information outflow to any third party.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-255972 filed on Sep. 2, 2004 including specification, claims, drawings and abstract is incorporated herein by reference in its entirety.

What is claimed is:

1. An electronic mail communication system for sending an electronic mail from a sending side communication apparatus to a reception side communication apparatus through a network, wherein:
the sending side communication apparatus comprises:
a processing instruction unit that instructs, when sending the electronic mail including an attached file, a content of processing of the attached file to be performed in the reception side communication apparatus;
an electronic mail generation unit that generates an electronic mail including the processing content instructed by the processing instruction unit; and
a sending unit that sends the electronic mail generated by the electronic mail generation unit to the reception side communication apparatus; and
the reception side communication apparatus comprises:
a reception unit that receives the electronic mail including the processing content from the sending side communication apparatus;
an extraction unit that extracts the processing content from the electronic mail received by the reception unit; and
a processing unit that implements processing of the electronic mail received by the reception unit on the basis of the processing content extracted by the extraction unit.

2. The electronic mail communication system of claim 1, wherein
the processing instruction unit instructs processing for automatically printing the attached file, and
the processing unit automatically prints the attached file when receiving the electronic mail.

3. The electronic mail communication system of claim 1, wherein
the processing instruction unit instructs processing for automatically printing a specified part of the attached file, and
the processing unit automatically prints the specified part of the attached file when receiving the electronic mail.

4. The electronic mail communication system of claim 3, wherein
the processing instruction unit comprises:
a printing range specification unit that specifies a printing range of the attached file.

5. The electronic mail communication system of claim 1, wherein
the processing instruction unit instructs processing in which the attached file is processed in accordance with a setting in the reception side communication apparatus; and
the processing unit processes the attached file in accordance with the setting in the reception side communication apparatus when receiving the electronic mail.

6. The electronic mail communication system of claim 1, wherein
the processing instruction unit instructs processing in which printing of the attached file is inhibited; and
the processing unit inhibits printing of the attached file when receiving the electronic mail.

7. The electronic mail communication system of claim 6, wherein
the processing instruction unit comprises:
a password setting unit that sets a password; and
the processing unit permits the printing of the attached file which has been inhibited to be printed, when the password set by the password setting unit is inputted.

8. An electronic mail communication apparatus for sending an electronic mail to a reception side communication apparatus through a network, comprising:
a processing instruction unit that instructs, when sending the electronic mail including an attached file, a content of processing of the attached file to be performed in the reception side communication apparatus;
an electronic mail generation unit that generates an electronic mail including the processing content instructed by the processing instruction unit; and
a sending unit that sends the electronic mail generated by the electronic mail generation unit to the reception side communication apparatus.

9. An electronic mail communication apparatus for receiving an electronic mail sent from a sending side communication apparatus through a network, comprising:
a reception unit that receives an electronic mail including an instruction of a processing content for an attached file sent from the sending side communication apparatus;
an extraction unit that extracts the processing content from the electronic mail received by the reception unit; and
a processing unit that implements processing of the electronic mail received by the reception unit on the basis of the processing content extracted by the extraction unit.

10. A controlling method for an electronic mail communication system for sending an electronic mail from a sending side communication apparatus to a reception side communication apparatus through a network, comprising:
instructing, by a processing instruction unit of the sending side communication apparatus, a content of processing of an attached file to be performed in the reception side communication apparatus when sending the electronic mail including the attached file;
generating, by an electronic mail generation unit of the sending side communication apparatus, an electronic mail including the processing content instructed by the processing instruction unit;
sending, by a sending unit of the sending side communication apparatus, the electronic mail generated by the electronic mail generation unit to the reception side communication apparatus;
receiving, by a reception unit of the reception side communication apparatus, the electronic mail including the processing content from the sending side communication apparatus;
extracting, by an extraction unit of the reception side communication apparatus, the processing content from the electronic mail received by the reception unit; and
implementing, by a processing unit of the reception side communication apparatus, processing of the electronic mail received by the reception unit on the basis of the processing content extracted by the extraction unit.

11. A storage medium readable by a computer, the storage medium storing an electronic mail processing program executable by the computer to perform a function for processing in an electronic mail communication system which sends an electronic mail from a sending side communication apparatus to a reception side communication apparatus through a network, the function comprising:
inputting an instruction of a content of processing of an attached file to be performed in the reception side communication apparatus when sending the electronic mail including the attached file from the sending side communication apparatus;
generating an electronic mail including the processing content inputted;
sending the generated electronic mail to the reception side communication apparatus;
receiving the electronic mail including the processing content from the sending side communication apparatus;
extracting the processing content from the received electronic mail; and
implementing processing of the received electronic mail on the basis of the extracted processing content.
